(19) United States
(12) Patent Application Publication
(10) Pub. No.: US 2025/0279011 A1
(43) Pub. Date: Sep. 4, 2025

(54) Continuous Success Model

(71) Applicant: Paresh B. Fozdar, Elmhurst, NY (US)

(72) Inventor: Paresh B. Fozdar, Elmhurst, NY (US)

(21) Appl. No.: 18/165,981

(22) Filed: Feb. 8, 2023

(51) Int. Cl. G09B 19/00

(52) U.S. Cl. CPC G09B 19/00

(57) ABSTRACT

The Continuous Success Model is generalized to work in any field for progress and growth. The model empowers in identification of generalized goals to achieve and sustain the Success, to develop a Model representation to define path and direction towards achieving goals, process to overcome the problems encountered in the Success path, continuity by iterative actions to measure and quantify the Success at every step, and, self-reward ability to sustain the Success. The Continuous Success Model Rewards with the Leadership capability towards the social well-being

### PLAN TO SUCCESS

### Approach

Develop and Maintain a Mindset

Strategic and Agile Approach to Life

Social Contribution

All the above together, fuels my motivation in maintaining Success.

### Goals

### Develop and Maintain a Mindset of:

Growth

Value Generation

High Ethics

### Strategic and Agile Approach to Life:

Manage Risk/Resilience

Maintain Positivity

Create, Execute and Contribute to the Vision

### Social Contribution:

Volunteer

Mentor

Understand

### Single Target Goal

I would launch my journey to gain Success by approaching the below task

Create, Execute and Contribute to the Vision

### Pros

This Goal will enable me to start thinking in the direction to Success

This will become a Holistic approach which allows me to think in direction of my interest

A Ripple-Effect will be generated. This will produce chunks, acts as pieces of puzzle, towards short-term Rewards

This goal will provide a shape for my Social Contribution Effort while gaining the right Mindset characteristics

As the Success direction is auto-defined, Short-term gains would be visible in chunks

### Cons

Long-term effect will be invisible

Challenging to find optimal path, will require iterative refinement at every stage

### Personal Gain

Self-Confidence boosted for every achievement in the approach to Success

Replicate the approach, apply probabilities and develop Mental Representations to maintain Success

Rework the proven approach to address larger goals

### Feasibility

Most Successful Personalities have achieved their Goal, with variable complexities, however the approach is always customized and agile

### PATH TO REALIZE AND MAINTAIN CONTINUOUS SUCCESS

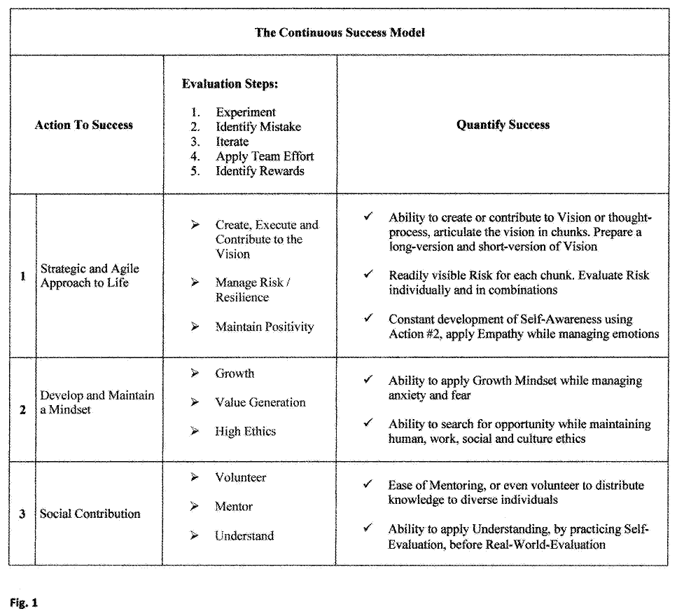

Refer to FIG. 1

### DISTRACTION TO PROGRESS

Possible Distraction to Progress, can occur, by constant focus on Value Generation Mindset

As long as the direction is evaluated intermittently; and it is towards the Goal, the short-term rewards are visible of achieved, then this task may be eliminated from the equation to Success

Reward towards Self-Awareness

Discomfort is key driver Success

Well-Being significance, must be realized and managed by tactful balance of Resiliency (i.e. Stress, persistence)

1. The Continuous Success Model is generalized to work in any field for progress and growth

2. The model empowers:
a. Identification of generalized goals to achieve and sustain the Success
b. A Model representation to define path and direction towards achieving goals
c. Process to overcome the problems encountered in the Success path
d. Continuity by iterative actions to measure and quantify the Success at every step
e. Self-reward ability to sustain the Success

3. The Continuous Success Model Rewards with the Leadership capability towards the social well-being
